(19) United States
(12) Patent Application Publication
(10) Pub. No.: US 2003/0088556 A1
(43) Pub. Date: May 8, 2003

(54) System and method of geolocating a response to a query initiated by an individual from an information site

(76) Inventor: John H. Allen III, Dallas, TX (US)

Correspondence Address: HUGHES & LUCE LLP, 1717 MAIN STREET, SUITE 2800, DALLAS, TX, 75201, US

(21) Appl. No.: 10/279,445

(22) Filed: Oct. 24, 2002

Related U.S. Application Data
(60) Provisional application No. 60/335,058, filed on Oct. 24, 2001.

(51) Int. Cl. G06F 7/00

(52) U.S. Cl. 707/3

(57) ABSTRACT

The present invention provides a method and system of providing a response from a local source to a query placed in a query box. The method involves the steps of linking a query box located on a network site through a network such as the Internet to a first server. This query is received by a server and then analyzed to determine the location of the person entering the query. The system or method locates a respondent to answer the person's query wherein the respondent is geographically the nearest respondent to the person within a given jurisdiction. The present invention then forwards the query to that respondent.

### RELATED APPLICATIONS

This application claims the benefit of and priority to U.S. Provisional Patent Application Ser. No. 60/335,058 entitled “Geolocating Query And Response System And Methodology” filed on Oct. 24, 2001 to John H. Allen III.

### TECHNICAL FIELD OF THE INVENTION

The present invention relates to Internet business methods generally, and more specifically relates to dynamically determining the geo-location of a person submitting a query and geographically choosing a responder to the query.

### BACKGROUND OF THE INVENTION

The Internet allows people to search for information and dynamically access web sites to find information relating to their area of interest. Web businesses currently provide methods for users to submit a question or query to the web site to receive more information regarding a particular aspect of that person's interests. Often, the web site company answers the query itself.

Many queries, especially those concerning professional services, from web site customers are geographically specific. The answer to these questions may depend on the location of the person submitting the question. When the questions relate to professions or services that are state specific, such as the legal profession, or when the responder looks to develop a business relationship with the user, such as when a person has a question regarding laser eye surgery, the answer depends on the geographic location of the party asking and answering the question. One typical category of Internet business sites involves sites wherein people can be referred to attorneys for legal advice.

Typically, in these business methods, attorneys pay web site companies a fee in order to be placed on a referral list located on a Web site. Users contact the attorney directly by “clicking” on the attorney's name which links them to the attorney's email address. This places the user at a disadvantage with the choice of giving up some personal information (namely, the user's email address and the type of question the user has) or not seeking a response to her query. Additionally, users are at the mercy of the attorney for a response. Quite often, the attorney may not even be from her jurisdiction, thereby limiting the effectiveness of the response.

In other cases, users present generic legal questions to a web site for an answer. However, generic legal questions have different answers depending on the jurisdiction where the person resides. Currently, no web site has developed a method to ensure that the respondent is geographically located near the user. This is desirable so that a business relationship may develop between the user and the respondent. Typically, respondents to the query are randomly chosen and are geographically located nowhere near the person's jurisdiction, thereby providing a faulty response at best.

### SUMMARY OF THE INVENTION

The present invention provides a geographically intelligent answer to a query that substantially eliminates or reduces disadvantages and problems associated with previously developed question and answer web sites.

More specifically, the present invention provides a method of responding to a query placed in a query box from a local source. The method first links electronically, a query box located on a network site such as a World Wide Web site, to a server via a network such as the Internet or other like network known to those skilled in the art. The server receives a query from a person entering the query into the query box. The location of the person entering the query is determined. A respondent for the person's query is located. The respondent typically is, geographically, the nearest respondent to the person within a given jurisdiction. The present invention then forwards the query to the nearest geographically located respondent.

Also, the present invention may take the form of an information system that forwards a query from a person to a respondent who is the located geographically nearest to the person. The system links a query box located on a network site through a network such as the Internet to a first server. It should be noted that this query box is independent of the network site, but incorporated into the display of the network site. This query is received by a server and then analyzed to determine the location of the person entering the query. The system or method locates a respondent to answer the person's query wherein the respondent is geographically the nearest respondent to the person within a given jurisdiction. The present invention then forwards the query to that respondent.

Additionally, the present invention provides an apparatus that forwards a query from a person to a respondent, where the respondent is located geographically nearest to the person. The apparatus comprises a first server, connected to a query box through a communication pathway such as the Internet. The query box is located within a network site such as a World Wide Web site. A database located on the first server contains the geographic location of a respondent, and the respondents corresponding email address. An algorithm or code located on the server processes received queries supplied via the query box, compares the location of the source of the query to the database, and forwards the query to the respondent located geographically nearest to the person initiating the query but within the same jurisdiction.

The foregoing outlines some of the more pertinent objects and features of the present invention. These objects should be construed to be merely illustrative of some of the features that are more prominent and applications of the invention. Many other beneficial results can be attained by applying the disclosed invention in a different manner or modifying the invention as will be described. Accordingly, other objects and a fuller understanding of the invention may be had by referring to the following Detailed Description of the Preferred Embodiment.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1A shows an example of a first web site with a first query box located thereon;

FIG. 1B provides an example of a second web site with a second query box located in a different location;

FIG. 1C depicts an example of a third web site with a third query box located in a different location;

FIG. 2A shows an example of a query box located on a web site that provides legal information;

FIG. 2B provides an example of another query box located on a legal information or reference web site;

FIG. 2C depicts an example of the third query box located on a health related web site;

FIG. 3 provides a block view of a query string;

FIG. 4 shows a block view of a response string;

FIG. 5 depicts a flow chart of the methodology utilized in the present invention; and

FIG. 6 provides a flow chart of a different methodology utilized in the present invention.

### DETAILED DESCRIPTION OF THE INVENTION

Preferred embodiments of the present invention are illustrated in the FIGS., like numerals being used to refer to like and corresponding parts of the various drawings.

The present invention provides a method and system of providing a response from a local source to a query placed in a query box. The method involves the steps of linking a query box located on a network site through a network such as the Internet to a first server. This query is received by a server and then analyzed to determine the location of the person entering the query. The system or method locates a respondent to answer the person's query wherein the respondent is geographically the nearest respondent to the person within a given jurisdiction. The present invention then forwards the query to that respondent.

The present invention allows a stable of professionals in various fields of expertise to act as exclusive advisors in their particular field of expertise, e.g. laser eye surgery or the law. In order to increase loyalty and response rate to queries, the present invention may limit the professional to one professional per area of expertise, per local geographical area depending on the size of the area, per jurisdiction, or other constraint as known to those skilled in the art.

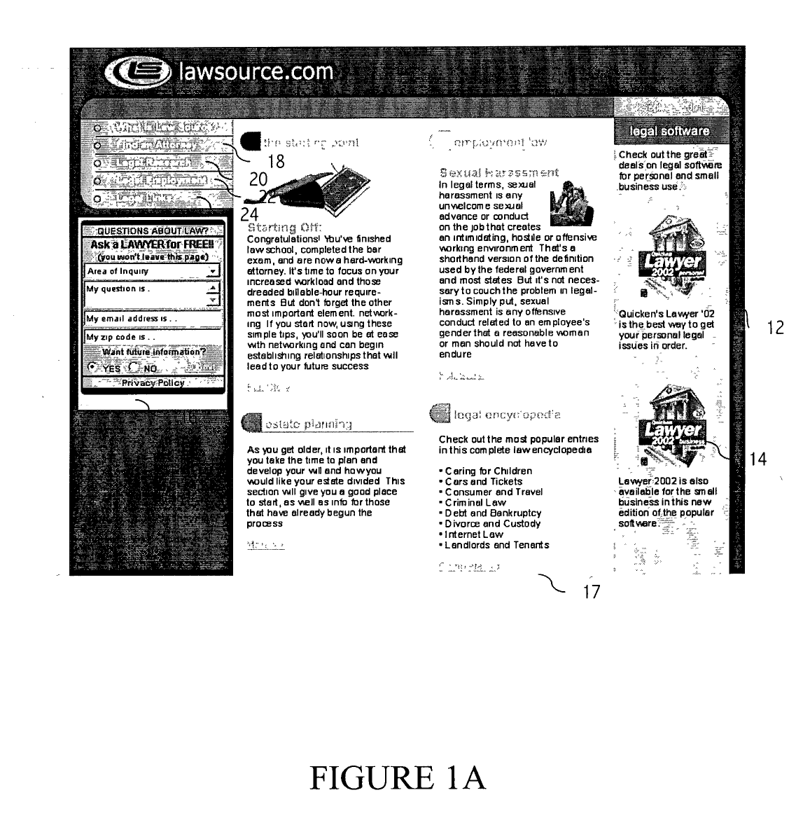

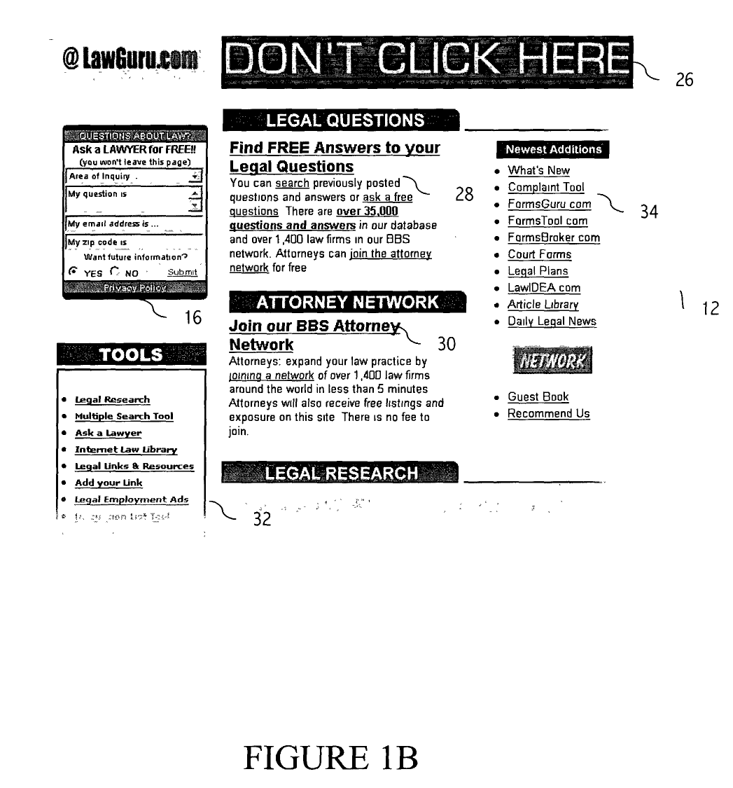

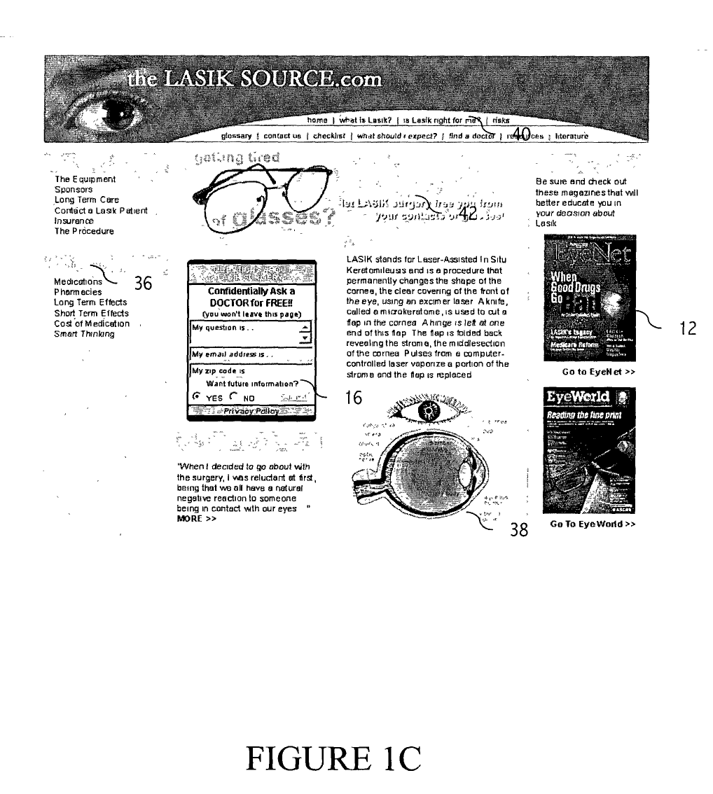

The present invention allows affiliated web sites to host a question box as shown in FIG. 1A. FIG. 1A depicts a web site as shown as viewed within an Internet browser. In FIG. 1A, question box 10 is located and presented as an integrated part of the web site 12. Web site 12 depicts a legal related web site, “lawsource.com,” which provides information associated with finding an attorney, conducting legal research, finding legal employment or other legal relocated links. Advertisements 14 are provided on the right-hand side of web site 12 while a general description 16 and links 18, 20, 22, and 24 provide information that compliments web site 12. These include finding an attorney through link 18, conducting legal research through link 20 which may be further expanded on in the main portion of the other web site. Links 22 and 24 provide other resources for legal employment or other law related links. FIGS. 1B and 1C depict other potential information sites 12 which contain question box 16. FIG. 1B illustrates another legal information site, namely the home page for “lawguru.com”. This site contains banner information 26, links to frequently asked questions 28, attorney network link 30, and other links and tools 32. Additionally, links to newly added-information sites or data resources 34 are provided. FIG. 1C depicts an embodiment of the present invention wherein information site 12 and question box 16 are contained within a health related information site. The health related information site provided in FIG. 1C is specifically tailored to laser assisted vision correction. As previously described in FIGS. 1A and 1B, the information site 12 of FIG. 1C contains question box 16 as well as links 36 to medical information, general information associated with the focus of this web page, link 38 is more specifically advertising 40, and/or banner ads 42.

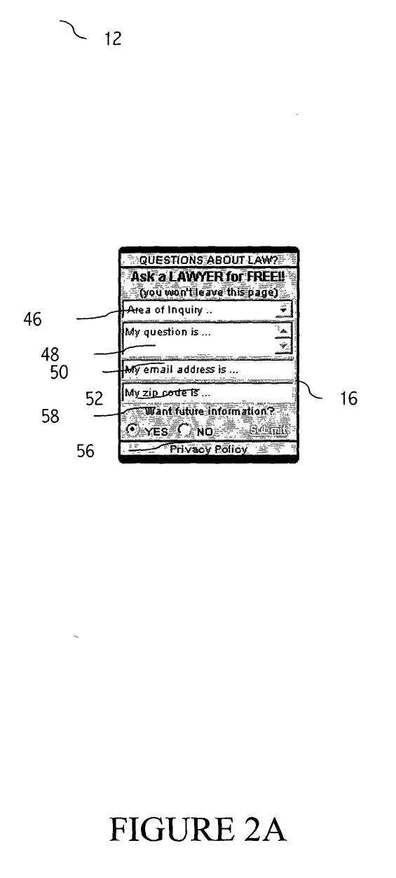

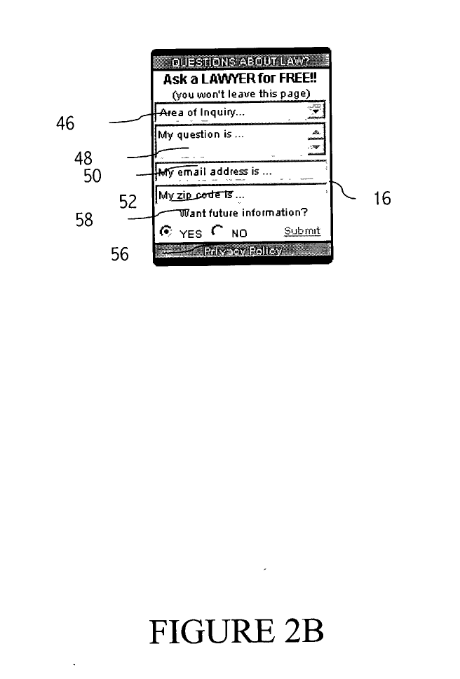

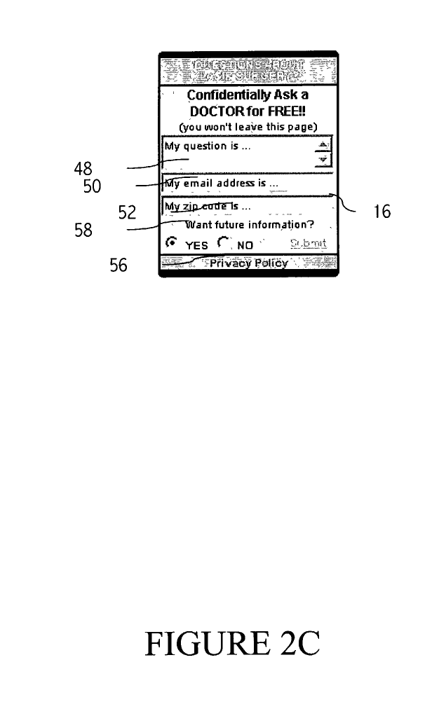

The questions box is more specifically represented in FIG. 2. Question box 16 allows potential clients, patients, or customers to interact with a local professional, despite the question box presence on a nationwide web page. This box may operate independently of the host web page. The question boxes are strategically located at the web users point of interest. For instance, a question box with a path to a local plastic surgeon will be placed upon a web page at a plastic surgery information web site or page.

Within question box 16, a visitor to an individual web site may select an area or field from which to ask a question by selecting an area of inquiry from drop-down list 46 and inputting the question within text box 48. An individual may provide their email address or other like contact information as is known to those skilled in the art via field 50. A zip code or other geographic locator is provided via field 52 and allows the present invention to determine the geographic location and jurisdiction within which the individual initiating the query is located. Submit button 54 allows the individual initiating the query to submit their finalized query for processing to the nearest professional capable of answering that query. Other links 56 may be associated with a privacy policy associated with the inquiry. Information option 58 allows users to choose whether the individual will receive future information associated with that field or marketed via a list compiled from users that utilized question box 16.

FIG. 2B depicts another embodiment of question box 16 wherein users are allowed to submit a question selected from an area of inquiry via scroll box 26 and to submit their individual questions via text box 48. Contact information is provided via text box 50 and a geographic locator such as a zip code or other like information is submitted via text box 52. When the user has completed these fields and is satisfied with their query, the user may submit their query via button 54.

Question box 16 provided within FIG. 2C is tailored towards laser vision correction. This illustrates that the question box 16 may not only be used to submit legal questions to legal professionals within a given jurisdiction or geographic region, but also to any professional such as an eye surgeon, as is shown in FIG. 2C. Additionally, the question box associated with the present invention may be used to submit queries to a variety of professionals such as engineers, accountants, healthcare professionals, legal professionals, government agencies, teachers, real estate professionals or other like professionals as is known to those skilled in the art. Again, question box 16 as shown in FIG. 2C has been tailored towards questions associated with laser vision correction. As the question box has been tailored to laser vision correction, the area of inquiry drop down list 46 contained within FIGS. 2A and 2B has been eliminated and the individual user directly submits their questions regarding vision correction via text box 48. Their email address may be supplied via box 50 and their zip code or other like geographic identifier is submitted via field 52. There may be instances where a geographic or jurisdictional indicator are improper wherein one may choose a question concerning a specific area within a field of interest. The type and make of the automobile may be chosen to shorten this deal. The question is submitted via button 54 and the individual is given the opportunity to receive further additional information via choice 58.

The present invention operates when a web user places a query in the question box without leaving the web page. The question box will usually request some location specific information regarding the user. Typically, this will be but is not limited to the user's zip code. Once the query and the user's location specific information is inserted into the question box, the user “submits” the question. The user never leaves the web site, from the user's point of view, when the question is submitted. Therefore, the question box assists the web site by enhancing the user's experience at that web site.

Once submitted, a central server electronically receives the query string and logs the query string into the server's database. Upon receiving the query, the server sends a message to the question box on the web site informing the user that the query has been received and a response will be returned within a pre-determined time.

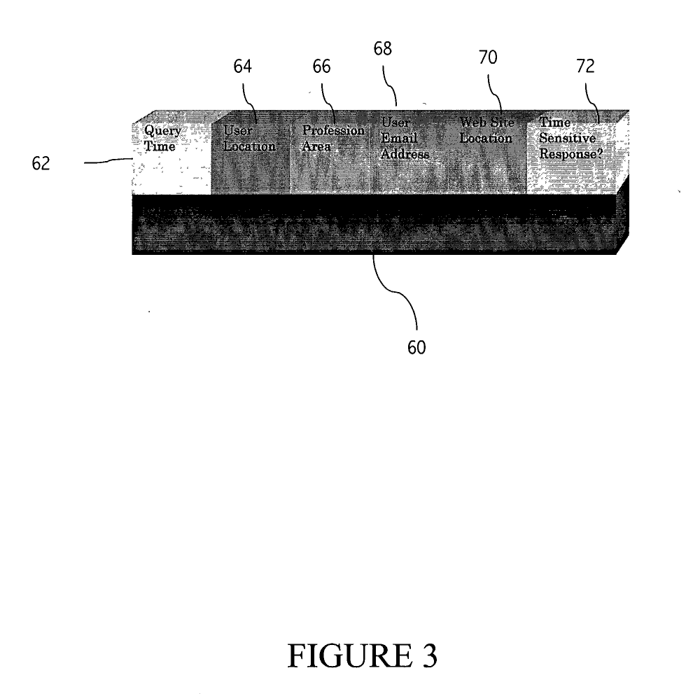

Query string 60, as illustrated in FIG. 3, comprises several pieces of information that make up query time 62. These pieces of information may include but are not limited to: query time 62, the location of the user associated with the individual user, an area of professional expertise 66 associated with the query, contact information 68 such as the user email address allowing a respondent to answer the user, web site information 70 associated with the web site from which the query was submitted and a measure of whether or not this is a time sensitive response. As discussed in FIGS. 2A through 2C, a professional area for area of inquiry may not be necessary as in the case of FIG. 2C where the question box is cleared for questions regarding a particular field. For example, laser vision correction as shown in FIG. 2C.

A general medical web site with a question box may cause the user to identify which area of medicine relates to their request for additional information. Such areas may include topics as known to those skilled in the art. Legal sites may similarly require the user to specify a particular area of the law, such as family law or trusts and estates. In a more general embodiment, the question box may allow users to choose from a more general list to specify the field of inquiry.

Once, the server logs the query string, the server compares the location information gathered to data within the central database. Then, the present invention may further delimit the search to the specific area of practice from which the user is seeking the response, depending on the query string.

Upon localizing the user's geographic location and the practice area, if relevant, the server thereupon formats the query into an email. Once compiled, the server matches the query with a respondent geographically located near the user from the database. The server thereupon chooses the appropriate respondent from its database based on the aforementioned query string results. Once chosen, the server emails the query to the respondent.

One aspect of the present invention provides the ability to limit access to the user's personal information from the respondent until the user specifically contacts the respondent. The present invention directs the query to the respondent and may mask the user's email address or other contact information by setting the return address as the server's query bin for that particular query.

The query bin may provide a placeholder or unique address within the server assigned to each query so that a response maybe returned to its associated query and thereupon forwarded onto the correct user. In this manner, the respondent does not receive the personal information regarding the user, such as the user's email information or other like contact information.

After sending the query to the respondent, the server starts a response clock and monitors the response time. In some embodiments it is desirable to ensure that the response time meets certain response criteria. Response criteria allow the server to send alerts to the respondent if the respondent has not complied with the response criteria. For example, response criteria may include a time limit for the respondent to respond to the query, a level of detail that the respondent must respond, user satisfaction of the response, or respondents passing on the response. The response clock allows the server to ensure that a response is set within an appropriate time, typically within forty-eight hours. An alert can be sent by the server to the respondent if a response has not been sent within a pre-determined limit to remind the respondent to address the query.

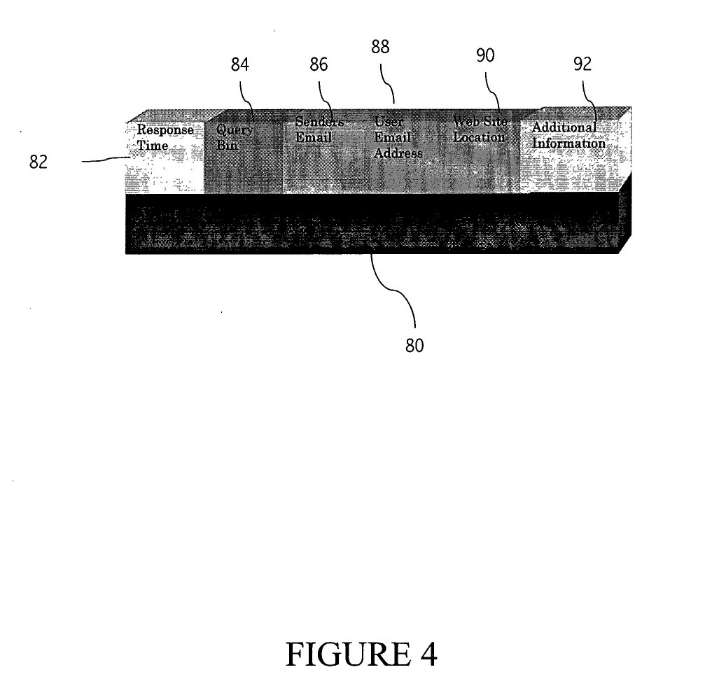

When the response is complete, the respondent “returns” the email to the server. The server in turn creates a response string within its central database. Response string 80 is depicted in FIG. 4. Response string 80 may include a response time 82, an identification for query identifier 84, the sender's email or other contact information 86, a user's email address 88 to which the response is directed, otherwise a response may be sent via other methods as known to those skilled in the art. Additionally, response 80 may include web site specific information associated with the web site 90 from which the query was initially received and additional information used to enhance and facilitate the user's experience.

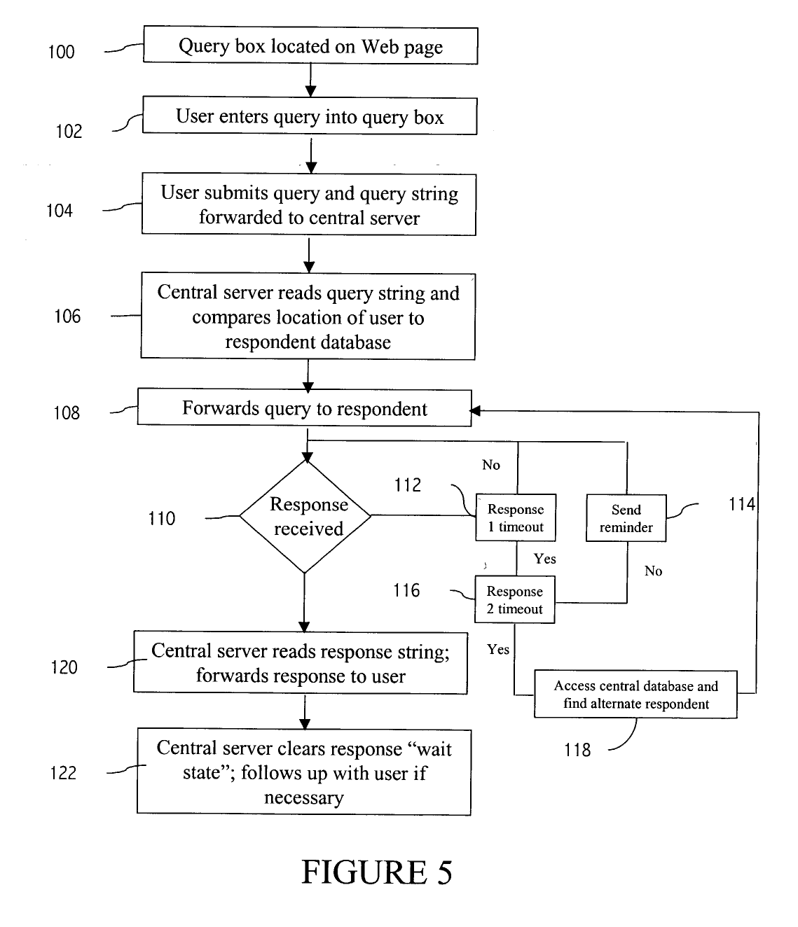

FIG. 5 provides a flowchart which describes the processes associated with the present invention. Here, at step 100, the query box is located on an information site such as a world wide web page. Upon viewing the query box contained within step 100, the user enters a query into the query box in step 102 wherein the user may or may not need to select an area of interest, and a geographic identifier associated with the query. Once the user has prepared the query and entered it into the query box, the user then submits the query, which is formatted into a query string and forwarded to a central server in step 104. The central server reads the query string and compares the location or jurisdiction of the user submitting the query to participants within a respondent database in step 106. This comparison allows the central server to determine which respondent within the database is located geographically closest to the individual submitted the query and, in some cases, within the jurisdiction or field of expertise associated with the query. At step 108, the central server forwards the query to the respondent most closely identified with the user submitting the query in step 106. Decision point 110 evaluates whether or not a response has been received from the respondent to which the query was originally forwarded. If this response was not received at decision point 110, an examination is made at step 112 to determine whether or not the response has timed out. If the response has in fact timed out, a reminder in step 114 may be sent to the respondent. Otherwise, the additional criteria in step 116 may be evaluated to determine whether or not these criteria have been exceeded. If they have, the central database is again accessed to identify an additional respondent to address the user's query at step 118. If the additional criteria have not been exceeded at step 116, again a reminder is sent to the respondent prompting the respondent to answer the user's query. Once the response is received at decision point 110, the central server reads the response to format a message to the user containing the response in step 120. This response may take the form of a website posting, e-mail, fax, voicemail communication, or other such communication as is known to those skilled in the art. In step 122, the central server clears the response wait state associated with this query from the queue and follows up with the user to determine their level of satisfaction or other associated characteristics associated with the system and the respondent. Furthermore, the user submitting the query may at that point determine whether or not they desire to contact the respondent.

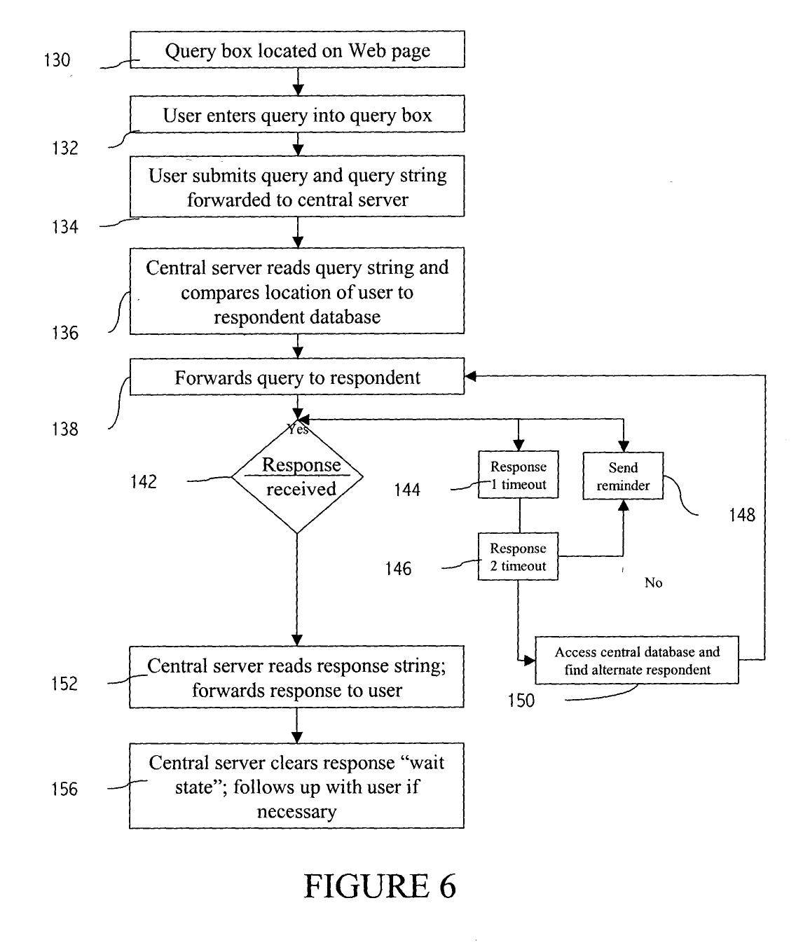

FIG. 6 provides another flowchart illustrating the method of the present invention. In step 130, a query box is located on an information site such as an Internet web page. Upon viewing this query box, a user may submit a query into the query box at step 132. Once the query has been submitted within the query box, the query is forwarded to a central server at step 134. Next, in step 136, the central server reads the query and compares the location or jurisdiction of the user to a respondent database. This comparison is made to determine which respondent within the database was closely associated with the field of interest, geographically closest and best equipped to give a response to the user. At step 138, the central server forwards a query to the respondent in the form of a unique web site location. Additionally, in step 140, the query itself is formatted into a unique web site. Decision point 142 evaluates whether or not the respondent has in fact responded to the query at the web site location. If the response has not been received and a predetermined amount of time has elapsed at step 144, additional criteria at step 146 may be applied to determine whether or not a reminder at step 148 should be forwarded to the respondent. This reminder is to prompt the respondent to answer the query located at the web site address. At step 146, if a decision is made not to send an additional reminder, the central server may again be accessed to determine an alternate respondent and delete the query on the web site in step 150. Once this is done, the query is again reformatted into a different unique web site location in step 148 and this new web site address is forwarded to the alternate respondent selected. However, if the response has been received at decision point 142, the central server formats the response into a message readable by the user. This message may take the form of a unique web site address, email, fax, voicemail, personal call or other like method of contacting an individual known to those skilled in the art in step 152. At step 156, the central server may request feedback from either the respondent or the individual submitting the query to determine their satisfaction with this process.

The present invention addresses problems associated with many legal web sites which provide directory information for individual attorneys. These legal directories on the web provide no more service than an electronic version of the Yellow Pages. This web site provides professional users the ability to uniquely make their services available to potential customers through a network such as the web. The present invention need not be only applied to legal related questions. All professionals may make use of the system and method provided by the present invention. These professionals may include accountants, medical and healthcare providers, attorneys, engineers, or other professionals or experts known to those skilled in the art. Additionally, by uniquely matching queries to respondents within the database, appropriate professionals are identified that are most capable of answering the individual's question or query within a given geographic area. This is particularly true with legal related information sites wherein a query may be answered by a professional without specific knowledge of the user's jurisdiction. This can cause erroneous information to be provided to individuals submitting queries. The present invention allows users to have a level of confidence associated with their received response. The present invention allows an individual to know that the person responding to their query is a trained professional within their jurisdiction or geographic area capable of properly handling their query. A proper response to a query is also more likely to generate business for that individual professional responding to the query. Additionally, the present invention maintains the anonymity or privacy of the individual submitting the query and also prevents the professional from engaging in unseemly advertisements to generate new business.

After logging the response string into a database, the server forwards the respondent's response to the user with the respondent's contact information. The users may thereupon initiate contact with the respondent if they so choose.

The present invention allows users to return a reply to the central server indicating the usefulness of the information received from the respondent and the likelihood of her contacting the respondent. This information is then returned to the central server for later evaluation of the respondent at a later time. This allows the operators to ensure that only respondents that evoke a high level of customer satisfaction are maintained on its respondent list.

Once the response is sent to the user, the server clears the response clock and query from a holding bin within the server, indicating that the query process has been completed.

Within another embodiment of the present invention, the central server places the user's question at a specific web site address for the responder to view prior to responding to the query. When the user submits the query, the central server receives and logs the query string into its query database. Thereupon, the server encodes the query in HTML format and places the query at a specific, unique Web site address for the query. After determining the correct geo-located respondent according to the method as stated above, the Web site address is forwarded to the respondent along with an email informing the respondent of the query. The respondent may then either “click” on the link provided in the email or enter in the correct address into the respondent's browser to access the correct address.

Once accessed, the respondent submits the response to the user's query in the space located on the Web site and “submits” the response to the central server. After the central server receives the response, the server logs the response string and forwards the response in an email or other user friendly format to the user. Again, the user in receipt of the response has the option of contacting the respondent. In this way, the user's privacy is maintained from the respondent unless the user decides otherwise.

The present invention provides a method of responding from a local source to a query placed in a query box. The method includes the steps of linking a query box located on a network site through a network such as the Internet or any other network as is known to those skilled in the art to a server. A query is received by the server from a person entering the query in a query box. Next, the query is analyzed to determine the location of the person entering the query. A respondent to answer the person's query is located such that the respondent being is geographically the nearest respondent to the person capable of answering the query. The query is then sent to the nearest geographically located respondent.

The present invention also provides a system of forwarding a query from a person to a respondent located geographically nearest to the person. The system includes a query box which may be placed within an information site such as a world wide web site. A server connects to the query box through a network and contains a database of electronic addresses of respondents. Users input the queries wherein the server receives location of the query and forwards the query to a respondent located geographically nearest to the person based on the database of respondents.

The present invention provides a method and system of providing a response from a local source to a query placed in a query box. The method involves the steps of linking a query box located on a network site through a network such as the Internet to a first server. This query is received by a server and then analyzed to determine the location of the person entering the query. The system or method locates a respondent to answer the person's query wherein the respondent is geographically the nearest respondent to the person within a given jurisdiction. The present invention then forwards the query to that respondent.

Although the present invention is described in detail, it should be understood that various changes, substitutions and alterations can be made hereto without departing from the spirit and scope of the invention as described by the appended claims.

What is claimed is:

1. A method of providing a response to a query initiated by an individual, comprising the steps of:
placing the query within a query box;
linking said query box to a server, wherein the query is received by said server;
analyzing the query to determine a geographic location associated with the query;
locating a respondent to answer the query, wherein said respondent is located within or proximate to said geographic location;
forwarding the query to said respondent located within or proximate to said geographic location, and wherein said respondent located within or proximate to said geographic location answers the query;
receiving at said server an answer to the query from said respondent located within or proximate to said geographic location;
formatting said answer into the response; and
sending the response to the individual.

2. The method of claim 1, wherein said query box is located an information site.

3. The method of claim 2, wherein said information site is a world wide web site.

4. The method of claim 1, wherein said query box is linked to said server via a network.

5. The method of claim 4, wherein said network comprises an Internet.

6. The method of claim 1, wherein the query contains a zip-code that may be used as a geographic locator.

7. The method of claim 1, wherein the individual's privacy is maintained from said respondent.

8. The method of claim 1, further comprising the step of tracking the query forwarded to said respondent located within or proximate to said geographic location to ensure the response is provided to the individual within a specified amount of time.

9. The method of claim 1, wherein the query is limited to a particular professional practice area.

10. The method of claim 9, wherein said particular professional practice area comprises a professional practice area selected from medical related information, surgical related information, legal related information, pharmacological related information, real estate related information, and accounting related information.

11. The method of claim 9, wherein the individual selects a particular professional practice area in said query box.

12. A method of providing a response to a query initiated by an individual, wherein the query is limited to a particular professional practice area, comprising the steps of:
placing the query within a query box, wherein said query box is located on an information site, and wherein the query contains a geographic locator;
linking said query box to a server, wherein the query is received by said server, and wherein said query box is linked to said server via a network;
analyzing the query to determine a geographic location associated with the query;
locating a respondent to answer the query, wherein said respondent is located within or proximate to said geographic location;
forwarding the query to said respondent located within or proximate to said geographic location, and wherein said respondent located within or proximate to said geographic location answers the query;
tracking the query forwarded to said respondent located within or proximate to said geographic location to ensure the response is provided to the individual within a specified amount of time;
receiving at said server an answer to the query from said respondent located within or proximate to said geographic location;
formatting said answer into the response; and
sending the response to the individual.

13. The method of claim 12, wherein said information site is a world wide web site.

14. The method of claim 12, wherein said network comprises an Internet.

15. The method of claim 1, wherein the individual's privacy is maintained from said respondent.

16. The method of claim 12, wherein said particular professional practice area comprises a professional practice area selected from medical related information, surgical related information, legal related information, pharmacological related information, real estate related information, and accounting related information.

17. The method of claim 12, wherein the individual selects a particular professional practice area in said query box.

18. A geolocating query and response system comprising:
a query box located on an information site operable to receive a query from an individual;
a server linked to said query box, wherein said query is received by said server, and wherein instructions executed at said server analyze the query to determine a geographic location associated with the query;
a database of respondents from which said server locates a respondent to answer said query, wherein said respondent is located within or proximate to said geographic location;
a means of forwarding said query to said respondent located within or proximate to said geographic location, and wherein said respondent located within or proximate to said geographic location answers said query; and
a means of sending answers to said query to said server from said respondent located within or proximate to said geographic location.

19. The geolocating query and response system of claim 18, wherein said information site is a world wide web site.

20. The geolocating query and response system of claim 18, wherein said query box is linked to said server via a network.

21. The geolocating query and response system of claim 20, wherein said network comprises an Internet.

22. The geolocating query and response system of claim 18, wherein said query contains a zip-code that may be used as a geographic locator.

23. The geolocating query and response system of claim 18, wherein the individual's privacy is maintained from said respondent.

24. The geolocating query and response system of claim 18, further comprising a means of tracking said query forwarded to said respondent located within or proximate to said geographic location to ensure the response is provided to the individual within a specified amount of time.

25. The geolocating query and response system of claim 18, wherein said query is limited to a particular professional practice area.

26. The geolocating query and response system of claim 25, wherein said particular professional practice area comprises a professional practice area selected from medical related information, surgical related information, legal related information, pharmacological related information, real estate related information, and accounting related information.

27. The geolocating query and response system of claim 18, wherein said individual selects a particular professional practice area in said query box.
